(19) United States
(12) Patent Application Publication
(10) Pub. No.: US 2016/0306477 A1
(43) Pub. Date: Oct. 20, 2016

(54) TOUCH PANEL

(71) Applicant: Samsung Display Co., Ltd., Yongin-si (KR)

(72) Inventors: Hee Young Lee, Suwon-si (KR); Hyeon Jeong Sang, Bucheon-si (KR); Eun Mi Seo, Cheonan-si (KR); Yun Jang, Seongnam-si (KR); Suk Choi, Hwaseong-si (KR)

(21) Appl. No.: 15/057,995

(22) Filed: Mar. 1, 2016

(30) Foreign Application Priority Data
Apr. 17, 2015 (KR) 10-2015-0054583

(51) Int. Cl. G06F 3/041; G02B 5/20; G02B 5/30; G06F 1/16

(52) U.S. Cl. CPC G06F 3/0412; G06F 3/0416; G06F 1/1652; G02B 5/208; G02B 5/3025; G06F 2203/04102

(57) ABSTRACT

This disclosure provides a touch panel including: a touch sensor; a phase difference film stacked on the touch sensor; and a touch panel configured to include a polarizer stacked on the phase difference film, wherein the touch panel includes an infrared-blocking substance. This results in a decrease in the curvature radius which in turn provides a touch panel with increased bending range and since the infrared radiation is also blocked due to the infrared-blocking agent, it prevents the breakage of displays due to infrared rays.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This application claims priority to and the benefit of Korean Patent Application No. 10-2015-0054583 filed in the Korean Intellectual Property Office on Apr. 17, 2015, the entire contents of which are incorporated herein by reference.

### BACKGROUND

1. Field

The present disclosure relates to a touch panel, and more particularly, to a touch panel for a flexible display device, which has a bending range that is expanded by a decrease in a curvature radius and through which infrared wavelength light is blocked.

2. Description of the Related Technology

Various display devices such as a liquid crystal display (LCD), a plasma display panel (PDP), an organic light emitting diode (OLED) device, a field effect display (FED), and an electrophoretic display device may receive input signals in a touch type by including a touch panel so as to be applied to diverse uses.

Recently, studies of techniques for manufacturing a display device including a touch panel by using a flexible material have been actively pursued. This flexible display device may be applied to new devices such as electronic books and electronic papers.

To develop the flexible display device, a touch panel is required and in addition it is necessary to be flexible. In order to prevent stress generation due to folding and unfolding of the flexible display device and the possible resulting breakage and to facilitate smoother folding and unfolding of the flexible display device, the thickness of the flexible display device needs to be reduced to decrease a curvature radius according to the folding of the flexible display device.

Therefore, a need for reducing the curvature radius of the flexible display device by decreasing the thickness of the flexible display device has become necessary.

### SUMMARY

The present disclosure has been made in an effort to provide a touch panel for a flexible display device which has an expanded bending range by a decrease in a curvature radius and through which light of an infrared wavelength region is blocked.

An exemplary embodiment provides a touch panel including: a touch sensor; a phase difference film stacked on the touch sensor; and a touch panel configured to include a polarizer stacked on the phase difference film, wherein the touch panel includes an infrared-blocking substance.

The polarizer may be made of a material including the infrared-blocking substance.

The touch panel may further include a first infrared blocking layer disposed between the polarizer and the phase difference film, and made of a material including the infrared-blocking substance.

In this case, the first infrared blocking layer may be made of a material having thermal resistance and chemical resistance.

The polarizer may be made of a material including a dye substance.

The polarizer may be made of a material including a mixture of the dye substance and a synthetic resin.

The touch panel may further include an adhesive layer disposed between the polarizer and the phase difference film to adhere the polarizer to the phase difference film, and the adhesive layer may be made of a material including the infrared-blocking substance.

In this case, a thickness of the polarizer and the adhesive layer may be in a range of 0 μm to 15 μm.

The polarizer may be made of a material including a mixture of the dye substance and a synthetic resin, wherein the synthetic resin is a liquid crystal substance.

The touch panel may further include a passivation layer stacked on the polarizer to protect the polarizer, and the passivation layer may be made of a material including the infrared-blocking substance.

In this case, a thickness of the polarizer and the passivation layer may be in a range of 0 μm to 15 μm.

The touch panel may further include a second infrared blocking layer disposed between the touch sensor and the phase difference film and made of a material including the infrared-blocking substance.

In this case, the second infrared blocking layer may be made of a material having chemical resistance.

The phase difference film may be made of a material having the infrared-blocking substance.

The touch panel may include one or more infrared-blocking substance selected from the group consisting of a diammonium-based compound, a polymethine-based compound, an anthraquinone-based compound, a phthalocyanine-based compound, a naphthalocyanine-based compound, and a thiol-nickel complex, to block infrared rays.

According to an exemplary embodiment, the touch panel is formed to be integrated with the polarizer, and thus the thickness of the flexible display panel is reduced to decrease the curvature radius. Accordingly, it is possible to provide the touch panel which can increase the bending range of the flexible display panel. Further, since the light of the infrared wavelength band is blocked, it is possible to prevent breakage of the display device caused by infrared rays.

### BRIEF DESCRIPTION OF THE DRAWINGS

FIG. 1 is an exploded perspective view of a display device including a touch panel according to an exemplary embodiment.

FIG. 2 is a cross-sectional view illustrating the touch panel taken along a line II-II of FIG. 1 according to an exemplary embodiment.

FIG. 3 is a cross-sectional view illustrating the touch panel taken along a line II-II of FIG. 1 according to an exemplary embodiment.

FIG. 4 is a cross-sectional view illustrating the touch panel taken along a line II-II of FIG. 1 according to an exemplary embodiment.

FIG. 5 is a cross-sectional view illustrating the touch panel taken along a line II-II of FIG. 1 according to an exemplary embodiment.

FIG. 6 is a cross-sectional view illustrating the touch panel taken along a line II-II of FIG. 1 according to an exemplary embodiment.

FIG. 7 is a cross-sectional view illustrating the touch panel taken along a line II-II of FIG. 1 according to an exemplary embodiment.

FIG. 8 to FIG. 10 are graphs illustrating analyses of optical characteristics of polarizers.

### DETAILED DESCRIPTION

As the disclosure allows for various changes and numerous embodiments, particular embodiments will be illustrated in the drawings and described in detail in the written description. However, this is not intended to limit the present disclosure to particular modes of practice, and it is to be appreciated that all changes, equivalents, and substitutes that do not depart from the spirit and technical scope of the present disclosure are encompassed in the present disclosure. As used herein, the term “and/or” includes any and all combinations of one or more of the associated listed items. Embodiments of the present disclosure will be described below in more detail with reference to the accompanying drawings. Those components that are the same or are in correspondence are rendered the same reference numeral regardless of the figure number, and redundant explanations are omitted.

It will be understood that although the terms “first”, “second”, etc. may be used herein to describe various components, these components should not be limited by these terms. These components are only used to distinguish one component from another. As used herein, the singular forms “a,” “an” and “the” are intended to include the plural forms as well, unless the context clearly indicates otherwise. It will be further understood that the terms “comprises” and/or “comprising” used herein specify the presence of stated features or components, but do not preclude the presence or addition of one or more other features or components.

In the drawings, the thickness of layers, films, panels, regions, etc., are exaggerated for explanation. In other words, since sizes and thicknesses of components in the drawings are arbitrarily illustrated for convenience of explanation, the following embodiments are not limited thereto. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present

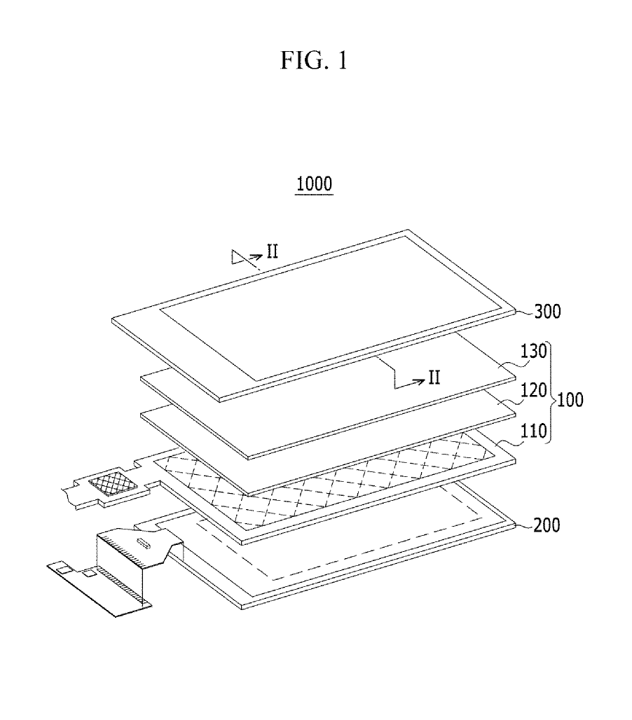

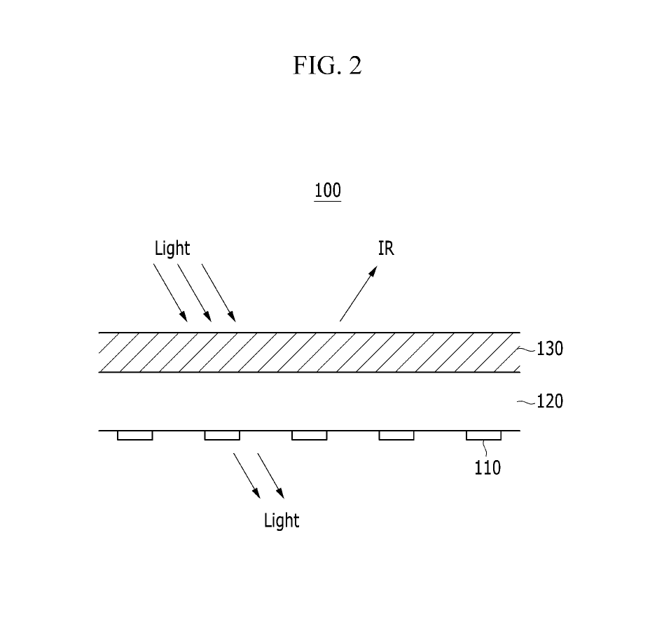

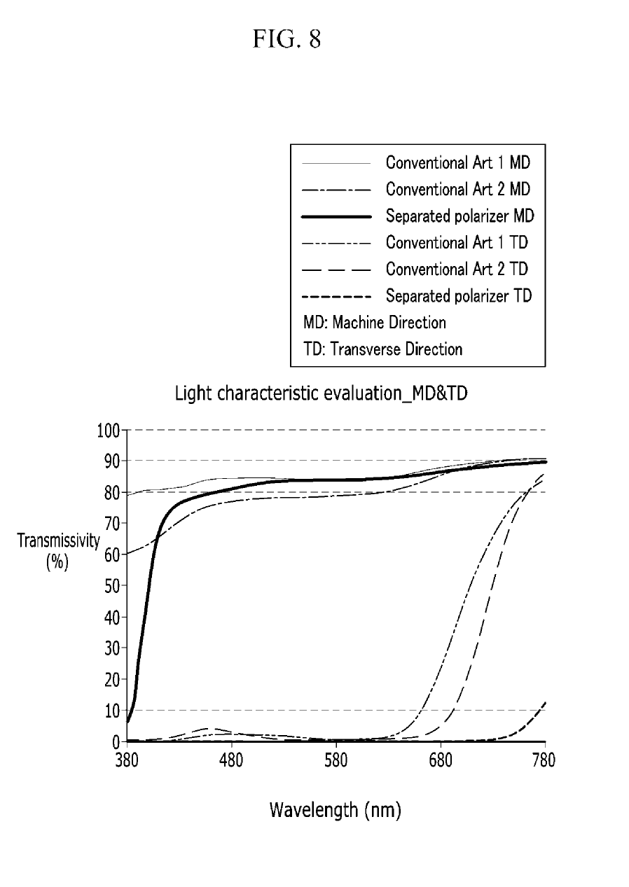

FIG. 1 is an exploded perspective view of a display device including a touch panel according to an exemplary embodiment. FIGS. 2-7 are cross-sectional views illustrating the touch panel taken along a line II-II of FIG. 1 according to exemplary embodiments. FIG. 8 to FIG. 10 are graphs illustrating analyses of optical characteristics of conventional polarizers.

In FIG. 1, the display device 1000 including the touch panel 100 according to the exemplary embodiment is illustrated. As illustrated in FIG. 1, the display device 1000 includes a display panel 200, the touch panel 100, and a window 300. The touch panel 100 included in the display device 1000 illustrated in FIG. 1 may correspond to touch panels illustrated in FIG. 2 to FIG. 7.

The display panel 200 actually generates images to be displayed by the display device 1000. The display panel 200 of the present exemplary embodiment may be made from various display panels, such as a liquid crystal display panel, a plasma display panel, an organic light emitting display panel, and the like, according to a structure and a principle of generating light, but it is not limited thereto.

Further, as in the present exemplary embodiment, the display panel 200 that is usable for the flexible display device 1000 may be made of a flexible material.

The touch panel 100 which includes touch sensors formed on a base substrate to sense an external touch pressure serves as a signal-input panel for converting a signal that is inputted in a touch type into an electric signal and transferring it. Therefore, the touch panel 100 is an input device for inputting a command by recognizing a user contact position.

The touch panel 100 of the present exemplary embodiment is disposed on a front surface of the display device 1000 to recognize a position at which a contact is made by a finger or an object and determine an input signal. Ways of implementing the touch panel 100 includes a resistive type, a capacitive type, an infrared type, an ultrasonic type, and the like, and the resistive type or the capacitive type are mainly employed.

In this case, the touch panel 100 may be provided as an integrated type with the polarizer 130 to make the flexible display device 1000 thinner. This will be described further in detail through exemplary embodiments.

The window 300 is disposed at an outermost portion of the display device 1000 according to the present exemplary embodiment in order to protect the inside of the display device 1000 by blocking the inside thereof from the external environment. The window 300 of the present exemplary embodiment may be made of a transparent material such as a glass or a synthetic resin since the window 300 needs to have a transparent optical characteristic for transferring light generated from the display panel 200 to the outside.

Further, as in the present exemplary embodiment, the window 300 for the flexible display device 1000 may be made of a flexible material.

As illustrated in FIG. 1, the touch panel 100 according to the exemplary embodiment may be disposed between the display panel 200 and the window 300, and may be provided as the integrated type with the polarizer 130 as described above.

In the embodiment where the touch panel 100 is integrated with the polarizer 130, the thickness of the display device 1000 including the integrated touch panel 100 is significantly reduced. Therefore, in the case where the touch panel 100 with a reduced thickness is applied to the flexible display device 1000, the curvature radius according to the bending thereof is reduced to further increase the bending range.

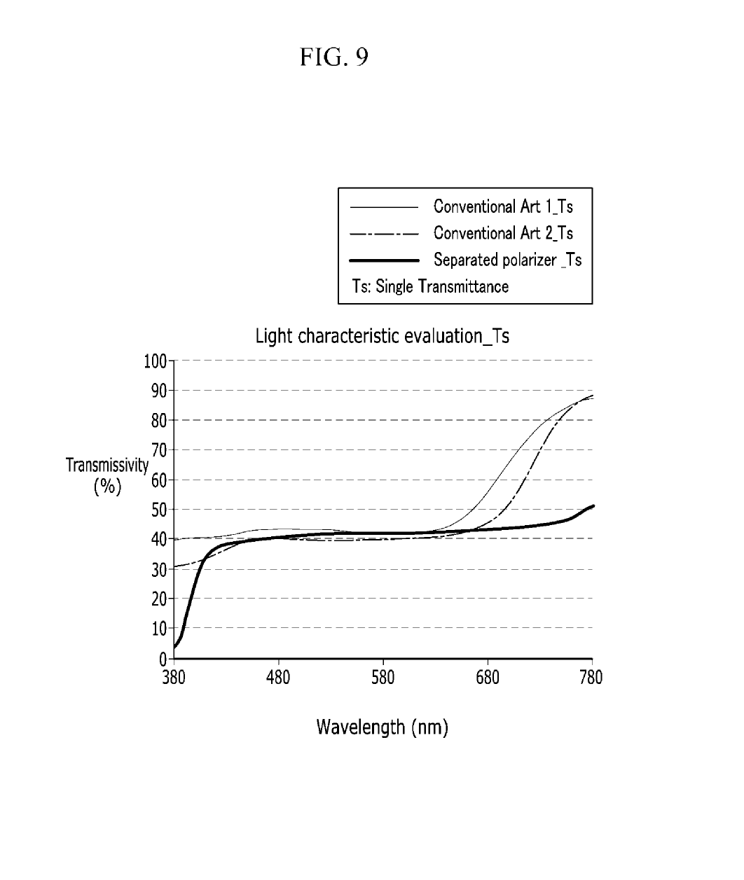

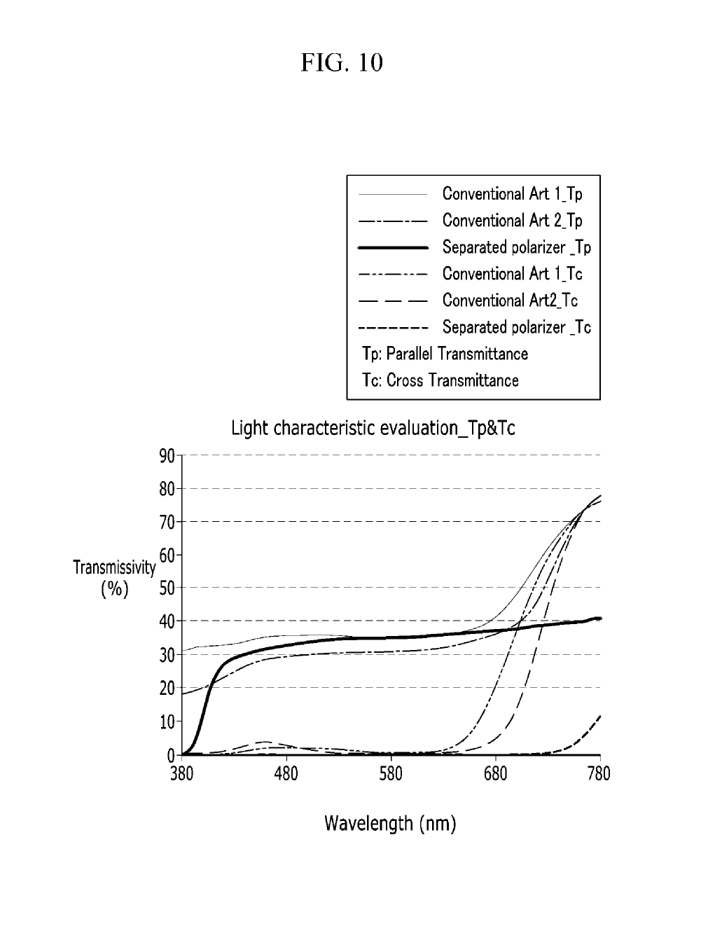

However, it is difficult to provide the flexible display device 1000 having an excellent optical characteristic by merely using the touch panel 100 integrated with the polarizer and as a result with reduced thickness. FIG. 8 to FIG. 10 are graphs illustrating optical characteristics of the display device 1000 to which the touch panel 100 integrated with the polarizer is applied. As illustrated in FIG. 8 to FIG. 10, although the touch panel 100 integrated with the polarizer is applied thereto, the transmittance of light of an infrared wavelength region of 600 nm or more is sharply increased. Therefore, the durability of the display device 1000 may be deteriorated due to the high transmittance of the light infrared wavelength. The transmissivity (%) of the “Separated Polarizers_Tc” is not increased for wavelength region of 600 nm or more compared to the “Conventional Art 1_Tc & 2_Tc” in FIGS. 8 and 10. Similarly, the transmissivity (%) of the “Separated Polarizer_Ts” is not increased for wavelength region of 600 nm or more compared to the “Conventional Art 1_Ts &2_Ts” in FIG. 9.

But the “Separated Polarizer_Tp” in FIG. 8 does show high transmissivity (%) for wavelength region of 600 nm or more like the “Conventional Art 1_Tp and 2_Tp” examples.

Hence, the touch panel 100 according to an exemplary embodiment includes touch sensors 110, a phase difference film 120, and a polarizer 130, and may further include a polarizer 130 or a phase difference film 120 which is made of a material for blocking infrared radiation, or may allow any one of the constituent elements constituting the touch panel 100 to include an infrared-blocking substance by including an infrared-blocking layer made of a material for blocking the light of the infrared wavelength band between the constituent elements.

In the present exemplary embodiment, the infrared-blocking substance is a material which absorbs light of a wavelength band of 900 to 1100 nm and may include one or more infrared-blocking substance selected from the group consisting of a diammonium-based compound, a polymethine-based compound, an anthraquinone-based compound, a phthalocyanine-based compound, a naphthalocyanine-based compound, and a thiol-nickel complex, but is not limited thereto. In addition thereto, any material which absorbs the light of the wavelength range from 900 to 1100 nm may be employed as the infrared-blocking substance.

The touch sensors 110 are formed in the touch panel 100 to convert touch pressures inputted to the touch panel 100 into electric signals. The touch sensors 110 according to the present exemplary embodiment are configured on a transparent insulator film by forming an X-axis electrostatic electrode and a Y-axis electrostatic electrode each of which is made of a light-transmitting conductor and a pad formed of a lead wire with silver paste on the edges of the electrostatic electrodes such that the X-axis electrostatic electrode and the Y-axis electrostatic electrode are vertically stacked or are adjacently arranged on the same plane by adding an adhesive layer or an insulator layer thereto.

The touch sensor 110 of the present exemplary embodiment may be formed by using ITO as the light-transmitting conductor, or by using silver nanowires (AgNW) or in a metal-mesh configuration, but the present disclosure is not limited thereto.

When a signal is inputted by a touch pressure applied to the touch sensor 110, the inputted signal is converted into an electric signal and is transferred to a controller. Then, the controller is driven by receiving the electric signal and outputs a coordinate signal.

The phase difference film 120 which serves to perform phase delay on light passing therethrough by λ/4 can convert linearly-polarized light passing through the phase difference film 120 into circularly-polarized light, and vice versa.

The polarizer 130 has a polarization axis, and adjusts an optical axis of light emitted to the outside through the display panel 200. Specifically, the light passing through the polarizer 130 can be linearly polarized in a direction of the polarization.

According to an exemplary embodiment, the polarizer 130 may be integrated so as to include in the touch panel 100, and hence can be thicker compared to being formed separately from the touch panel 100, thereby reducing the thickness of the display device 1000 and increasing the bending range by decreasing the curvature radius of the flexible touch panel 100.

In the present exemplary embodiment, the polarizer 130 may be formed as a coating layer that is formed using a coating method using a dye substance in which an aromatic compound-based chemical material and a liquid crystal are mixed, but the present disclosure is not limited thereto.

In this case, the touch panel 100 according to the present exemplary embodiment may include the polarizer 130 or the phase difference film 120 made of a material for blocking the light of the infrared wavelength, or may include including an infrared-blocking layer made of an infrared-blocking substance for blocking the light of the infrared wavelength band between constituent elements.

As described above, the light of the infrared wavelength band according to the present exemplary embodiment indicates light of a wavelength range from 900 to 1100 nm, and the infrared-blocking substance may include one or more substance selected from the group consisting of a diammonium-based compound, a polymethine-based compound, an anthraquinone-based compound, a phthalocyanine-based compound, a naphthalocyanine-based compound, and a thiol-nickel complex.

Hereinafter, various exemplary embodiments of the touch panel 100 integrated with the polarizer 130 which can reduce a curvature radius due to its reduced thickness and can prevent breakage of the display device 1000 caused by light of an infrared wavelength band will be described with reference to FIG. 2 to FIG. 7.

FIG. 2 is a cross-sectional view illustrating the touch panel 100 taken along a line II-II of FIG. 1 according to a first exemplary embodiment.

As illustrated in FIG. 2, the polarizer 130 of the touch panel 100 according to the present exemplary embodiment may be made of a material including an infrared-blocking substance. As described above, the infrared-blocking substance included in the polarizer 130 according to the present exemplary embodiment may include one or more substance selected from the group consisting of a diammonium-based compound, a polymethine-based compound, an anthraquinone-based compound, a phthalocyanine-based compound, a naphthalocyanine-based compound, and a thiol-nickel complex, but it is not limited thereto. As described above, any material which absorbs the light of the wavelength range from 900 to 1100 nm may be employed as the infrared-blocking substance.

Hence, the light of the infrared wavelength band is blocked by the polarizer 130 of the present exemplary embodiment and thus is unable to pass through the touch panel 100. Thus, it is possible to prevent the durability of the display device 1000 from being deteriorated due to the light of the infrared wavelength band.

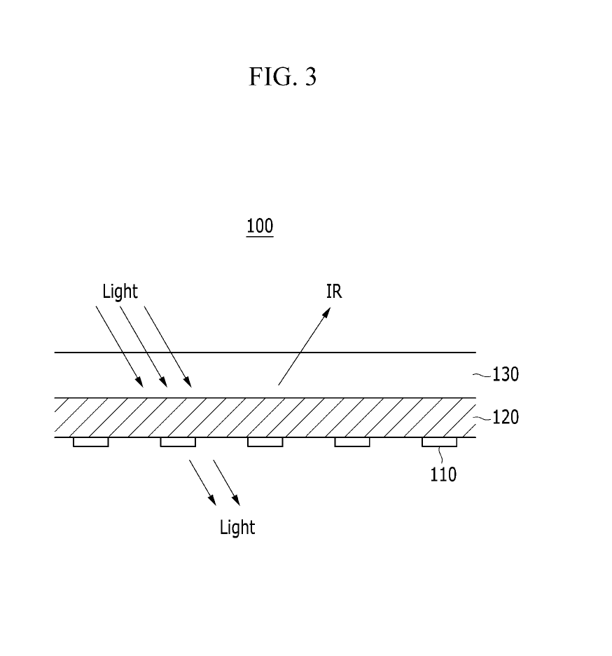

FIG. 3 is a cross-sectional view illustrating the touch panel 100 taken along a line II-II of FIG. 1 according to another exemplary embodiment.

As illustrated in FIG. 3, the phase difference film 120 of the touch panel 100 according to the present exemplary embodiment may be made of a material including an infrared-blocking substance. According to the present exemplary embodiment, light of an infrared wavelength band is blocked by the phase difference film 120 made of the infrared-blocking substance and thus is unable to pass through the touch panel 100. Thus, it is possible to prevent the durability of the display device 1000 from being deteriorated due to the light of the infrared wavelength band.

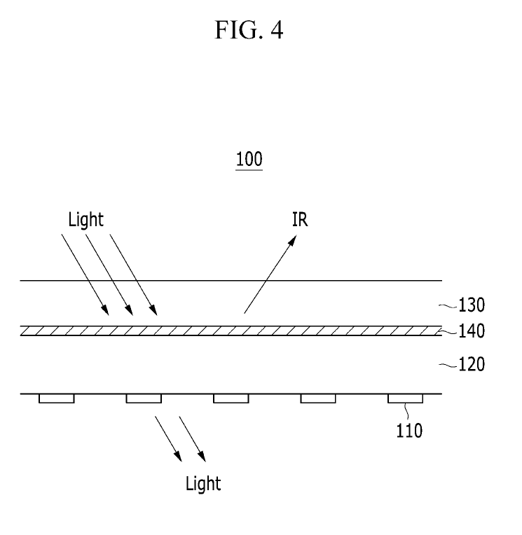

FIG. 4 is a cross-sectional view illustrating the touch panel 100 taken along a line II-II of FIG. 1 according to another exemplary embodiment.

As illustrated in FIG. 4, the touch panel 100 according to the present exemplary embodiment further includes a first infrared blocking layer 140.

The first infrared blocking layer 140 is disposed between the polarizer 130 and the phase difference film 120 and is made of a material including an infrared-blocking substance. According to the present exemplary embodiment, the first infrared blocking layer 140 may be formed as a coating layer that is formed by coating the infrared-blocking substance on a surface of any one of the polarizer 130 and the phase difference film 120 in a liquid coating method, but the present disclosure is not limited thereto. For example, the first infrared blocking layer 140 may be formed by stacking a film including an infrared-blocking substance on a surface of any one of the polarizer 130 and the phase difference film 120.

According to the present exemplary embodiment, light of an infrared wavelength band is blocked by the first infrared blocking layer 140 disposed between the polarizer 130 and the phase difference film 120 and thus is unable to pass through the touch panel 100. Accordingly, it is possible to prevent the durability of the display device 1000 from being deteriorated due to the light of the infrared wavelength band.

In this case, the first infrared blocking layer 140 according to the present exemplary embodiment may be made of a material having thermal resistance and chemical resistance. A process of manufacturing the flexible display device 1000 including the touch panel 100 according to the present exemplary embodiment includes steps that are performed in a high-temperature environment and steps that cause exposure to various chemical materials such as a variety of organic solvents and etchants. Accordingly, in the case where the first infrared blocking layer 140 is made of the material having thermal resistance and chemical resistance, it is possible to prevent the touch panel 100 of the present exemplary embodiment from being broken by the first infrared blocking layer 140 even though the touch panel 100 is subjected to a process of exposing it to the high-temperature environment or a chemical material.

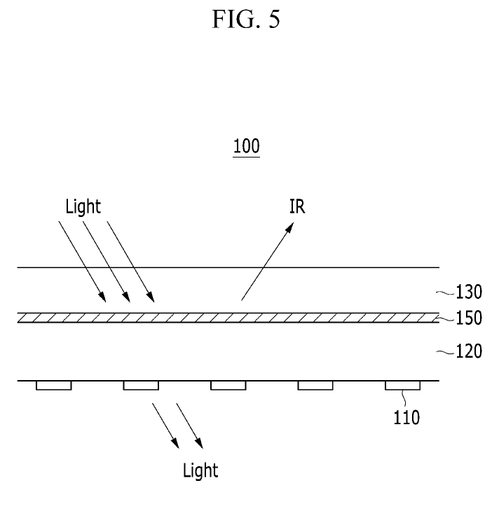

FIG. 5 is a cross-sectional view illustrating the touch panel 100 taken along a line II-II of FIG. 1 according to another exemplary embodiment.

According to the present exemplary embodiment, the polarizer 130 may be made of a material including a dye substance or a material including a mixture including a dye substance and a synthetic resin. For example, the synthetic resin of the present exemplary embodiment may include one or more substance selected from the group consisting of a guest-host type of liquid crystal in which dichroic dyes are dissolved in a host liquid crystal as a guest, but the present disclosure is not limited thereto. Alternatively, various synthetic resins may be used. In this case, polypropylene (P.P.), polyvinyl alcohol (P.V.A.), a lyotropic liquid crystal, a nematic liquid crystal, or a smectic liquid crystal exists as a host liquid crystal.

In this case, as illustrated in FIG. 5, the touch panel 100 of the present exemplary embodiment may further include an adhesive layer 150. The adhesive layer 150 is disposed between the polarizer 130 and the phase difference film 120 to adhere the polarizer 130 on the phase difference film 120.

The adhesive layer 150 of the present exemplary embodiment may be made of a material including an infrared-blocking substance for blocking light of an infrared wavelength band. According to the present exemplary embodiment, the light of an infrared wavelength band is blocked by the adhesive layer 150 including the infrared-blocking substance and thus is unable to pass through the touch panel 100. Accordingly, it is possible to prevent the durability of the display device 1000 from being deteriorated due to the light of the infrared wavelength band.

The adhesive layer 150 of the present exemplary embodiment may be a coating layer that is formed in a liquid coating method, and the thickness of the adhesive layer 150 and the polarizer 130 formed in the coating method may be in a range of 0 to 15 μm. Therefore, according to the present exemplary embodiment, the thickness of the touch panel 100 can be further reduced in comparison to the adhesive layer of thickness of 50 μm or more when the touch panel 100 is formed separately from the polarizer 130 as in the conventional art.

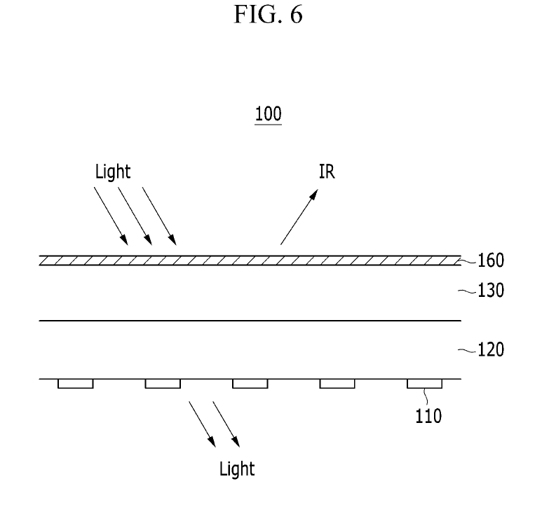

FIG. 6 is a cross-sectional view illustrating the touch panel 100 taken along a line II-II of FIG. 1 according to another embodiment.

The polarizer 130 of the present exemplary embodiment may be made of a material including a dye substance, and may be formed as a coating layer that is formed in a coating method using a dye substance in which an aromatic-compound based chemical material and a liquid crystal are mixed as described above.

In this case, as illustrated in FIG. 6, the touch panel 100 of the present exemplary embodiment may further include a passivation layer 160. The passivation layer 160 is stacked at an upper portion of the polarizer 130 to protect the polarizer 130.

According to the present exemplary embodiment, the passivation layer 160 may be made of a material including an infrared-blocking substance for blocking light of an infrared wavelength band. According to the present exemplary embodiment, the light of the infrared wavelength band is blocked by the passivation layer 160 including the infrared-blocking substance and thus is unable to pass through the touch panel 100. Accordingly, it is possible to prevent the durability of the display device 1000 from being deteriorated due to the light of the infrared wavelength band.

As described above, the infrared-blocking substance according to the present exemplary embodiment may include one or more substance selected from the group consisting of a diammonium-based compound, a polymethine-based compound, an anthraquinone-based compound, a phthalocyanine-based compound, a naphthalocyanine-based compound, and a thiol-nickel complex, but the present disclosure is not limited thereto. As described above, any material which absorbs the light of the wavelength range from 900 to 1100 nm may be employed as the infrared-blocking substance of the present exemplary embodiment.

The passivation layer 160 of the present exemplary embodiment may be a coating layer that is formed in a liquid coating method, and the thickness of the passivation layer 160 and the polarizer 130 formed in the coating method may be in a range of 0 to 15 μm. Therefore, according to the present exemplary embodiment, the thickness of the touch panel 100 can be further reduced in comparison to the passivation layer of thickness of 50 μm or more when the touch panel 100 is formed separately from the polarizer 130 as in the conventional art.

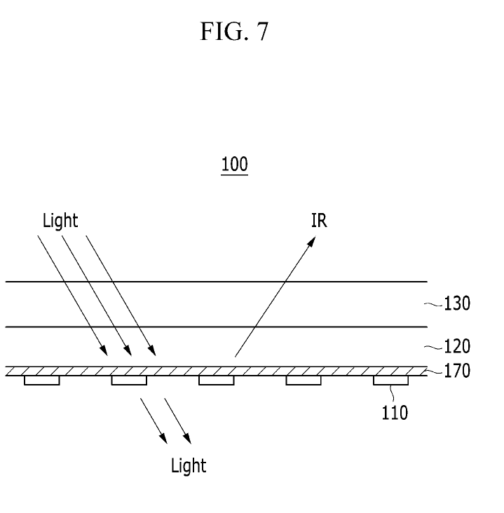

FIG. 7 is a cross-sectional view illustrating the touch panel 100 taken along a line II-II of FIG. 1 according to another exemplary embodiment.

According to the present exemplary embodiment, light of an infrared wavelength band is blocked by a second infrared blocking layer 170 disposed between the touch sensor 110 and the phase difference film 120 and thus is not able to pass through the touch panel 100. Accordingly, it is possible to prevent the durability of the display device 1000 from being deteriorated due to the light of the infrared wavelength band.

In this case, the second infrared blocking layer 170 of the present exemplary embodiment may be made of a material having chemical resistance. After the second infrared blocking layer 170 is formed and disposed between the touch sensor 110 and the phase difference film 120, a step of forming the touch sensor 110 may be performed. In this case, an etching process for forming a pattern while forming the touch sensor 110 may be performed. An etchant that is used in the etching process has a strong corrosive property which may damage the touch panel 100 of the present exemplary embodiment. Accordingly, the second infrared blocking layer 170 may be made of a chemical-resistant material serving as an etch stopper, and thus it is possible to obtain the touch panel which prevents chemical damage caused by an etchant.

Hereinbefore, the touch panel 100 integrated with the polarizer which can block light of an infrared wavelength band according to various exemplary embodiments has been described. According to the aforementioned exemplary embodiments, the touch panel 100 is formed to be integrated with the polarizer, and thus the thickness of the flexible display panel 200 is reduced to decrease the curvature radius. Accordingly, it is possible to obtain a touch panel 100 which can increase the bending range of the flexible display panel 200. Further, the light of the infrared wavelength band is blocked, and thus it is possible to prevent breakage of the display device 1000 caused by infrared rays.

Hereinabove, although exemplary embodiments are described in detail, the scope of the present disclosure is not limited thereto, and various modifications and reformations by a person of an ordinary skill in the art using a basic concept of the present disclosure defined in the following claims are also included within the spirit and scope of the appended claims. While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A touch panel comprising:
a touch sensor;
a phase difference film stacked on the touch sensor; and
a touch panel configured to include a polarizer stacked on the phase difference film,
wherein the touch panel includes an infrared-blocking substance.

2. The touch panel of claim 1, wherein the polarizer is made of a material including the infrared-blocking substance.

3. The touch panel of claim 1, wherein the phase difference film is made of a material having the infrared-blocking substance.

4. The touch panel of claim 1, wherein the polarizer is made of a material including a dye substance.

5. The touch panel of claim 1, further comprising:
a first infrared blocking layer disposed between the polarizer and the phase difference film, and made of a material including the infrared-blocking substance.

6. The touch panel of claim 5, wherein the first infrared blocking layer is made of a material having thermal resistance and chemical resistance.

7. The touch panel of claim 4, wherein the polarizer is made of a material including a mixture of the dye substance and a synthetic resin.

8. The touch panel of claim 1, further comprising:
an adhesive layer disposed between the polarizer and the phase difference film to adhere the polarizer to the phase difference film,
wherein the adhesive layer is made of a material including the infrared-blocking substance.

9. The touch panel of claim 8, wherein a thickness of the polarizer and the adhesive layer is in a range of 0 μm to 15 μm.

10. The touch panel of claim 8, wherein the polarizer is made of a material including a mixture of the dye substance and a synthetic resin.

11. The touch panel of claim 10, wherein the polarizer is made of a material wherein the synthetic resin is a liquid crystal substance.

12. The touch panel of claim 11, further comprising:
a passivation layer stacked on the polarizer to protect the polarizer, wherein the passivation layer is made of a material including the infrared-blocking substance

13. The touch panel of claim 12, wherein a thickness of the polarizer and the passivation layer is in a range of 0 μm to 15 μm.

14. The touch panel of claim 1, further comprising:
a second infrared blocking layer disposed between the touch sensor and the phase difference film and made of a material including the infrared-blocking substance.

15. The touch panel of claim 14, wherein the second infrared blocking layer is made of a material having chemical resistance.

16. The touch panel of claim 1, wherein the touch panel includes one or more infrared-blocking substance selected from the group consisting of a diammonium-based compound, a polymethine-based compound, an anthraquinone-based compound, a phthalocyanine-based compound, a naphthalocyanine-based compound, and a thiol-nickel complex, to block infrared rays.
